(19) United States
(12) Patent Application Publication
(10) Pub. No.: US 2020/0327593 A1
(43) Pub. Date: Oct. 15, 2020

(54) GUIDED CUSTOMIZATION WITH PREDETERMINED OPTIONS

(71) Applicant: KARMA AUTOMOTIVE LLC, Irvine, CA (US)

(72) Inventor: Fairuz Jane SCHLECHT, Irvine, CA (US)

(73) Assignee: KARMA AUTOMOTIVE LLC, Irvine, CA (US)

(21) Appl. No.: 16/406,334

(22) Filed: May 8, 2019

Related U.S. Application Data
(60) Provisional application No. 62/832,516, filed on Apr. 11, 2019.

(51) Int. Cl. G06Q 30/06; G06F 17/50; G06F 21/32

(52) U.S. Cl. CPC G06Q 30/0621; G06F 21/32; G06F 17/5095; G06Q 30/0641

(57) ABSTRACT

A method of guided customization for ensuring compatibility between selected design elements of a made-to-order vehicle for a current individual retail buyer. The method of guided customization includes predeveloping and predetermining combination guidelines between design element options and presenting to the current individual retail buyer only the design element option combinations that meet these guidelines. The method of guided customization also includes the option to restrict the option to select a combination based on a previous individual retail buyer registering the combination as exclusive and the option to allow the current individual retail buyer to register a unique combination as exclusive.

### CROSS REFERENCE TO RELATED APPLICATIONS

The present application claims priority to and the benefit of U.S. Provisional Patent Application No. 62/832,516 filed on Apr. 11, 2019. The foregoing provisional application is incorporated by reference herein in its entirety.

### BACKGROUND

The present disclosure relates to a method of guided customization for ensuring compatibility between selected design elements of a made-to-order vehicle for an individual retail buyer.

The modern automobile features a large number of parts, of which a significant fraction is ornamental. Commonly, these ornamental parts are chosen by expert designers to provide the most aesthetically pleasing design possible for the average consumer, but the custom automobile market often loops the individual retail buyer into the design decisions. Under normal circumstances, designing a custom automobile to meet the individual retail buyer's specifications while also remaining aesthetically pleasing requires the end buyer and designer to work closely together to decide upon a final design, often consuming more time than either party would prefer to spend.

Further, one of the foremost reasons an individual retail buyer may wish to design and purchase a custom automobile is for the privilege of owning a bespoke and unique variant of a given automobile model. Ensuring that an automobile is unique from a design perspective presents a challenge, as the various permutations of ornamental parts combinations may number well beyond the capacity of a person to track.

It is desirable to find an automated system for guiding the customization process of an automobile that ensures design compatibility between selected design elements while checking the selections for uniqueness.

### SUMMARY

Disclosed herein is a method of guided customization for ensuring compatibility between selected design elements of a made-to-order vehicle for a current individual retail buyer. In one embodiment, the method includes storing a plurality of design element types, each design element type having a plurality of possible design element options. In one embodiment, the method includes selecting a first design element type from the plurality of stored design element types and presenting the possible design element options for the first design element type. In one embodiment, the method includes recognizing a selection, by the current individual retail buyer, of a first design element option from the plurality of possible design element options for the first design element type, and repeating the selecting and recognizing process for a next design element type, until a selection has been recognized for each of the plurality of design element types. In one embodiment, the presenting of possible design element options for the next design element type is restricted based on a recognized selection of a previous design element option for a previous design element type. In one embodiment, the restriction based on the recognized selection of a previous design element option is based on a plurality of restriction criteria including manufacturer recommended combinations, design element manufacturing availability, and exclusivity rights of a previous individual retail buyer. In one embodiment, the method includes combining each of the recognized selections for each of the plurality of design element types into a design configuration, communicating to the current individual retail buyer how many times the design configuration has been ordered, and if the design configuration is unique, allowing the current individual retail buyer to register the design configuration as exclusive with respect to restricting design element options for a future individual retail buyer.

In another disclosed embodiment, each of the plurality of design element types is categorized as an interior design element, exterior design element, or a technological design element. In another disclosed embodiment, design element types categorized as interior design elements include types of thread, leather, textile, jewel, interior plating, control interfaces, floor mats, unique customer insignia, and manufacturer numbered insignia. In another disclosed embodiment, design element types categorized as exterior design elements include types of paint, finishes, wheel finishes, calipers, unique customer insignia, and manufacturer numbered insignia. In another disclosed embodiment, design element types categorized as technological design elements include types of sound systems, biometric recognition systems, screen applications, application stores, customized ecosystem, manufacturer ID feature configuration, advanced humanized machine interface, advanced welcome features, and advanced security features. In one embodiment, “sound systems” includes isolated sound zones for occupants of the made-to-order vehicle, wherein an isolated sound zone is assigned to each occupant of the made-to-order vehicle, and wherein each isolated sound zone is individually configurable. In one embodiment, the biometric recognition systems are able to identify occupants of the made-to-order vehicle and load personal settings for each of the occupants of the made-to-order vehicle based on recognized biometrics of the occupants of the made-to-order vehicle.

In another disclosed embodiment, upon delivery of the made-to-order vehicle, the current individual retail buyer is presented with a certificate of authenticity for at least one of the design element options selected and commissioned by the current individual retail buyer.

In another disclosed embodiment, the method includes presenting, to the current individual retail buyer, a preview of the selected design element options as a computer generated image. In another disclosed embodiment, the current individual retail buyer may adjust the presentation of the preview of the selected design element options.

In another disclosed embodiment, the manufacturer recommended combinations are based on a categorization of the combination of the selected design element options into a persona. In another disclosed embodiment, the method includes communicating the categorization of persona to the current individual retail buyer.

Other aspects, features, and techniques will be apparent to one skilled in the relevant art in view of the following detailed description of the embodiments.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 is a graphical representation of an exemplary embodiment of a system for implementing a method for ensuring compatibility between selected design elements of a made-to-order vehicle for a current individual retail buyer.

FIG. 2 is a flow chart depicting an exemplary process for guiding a current individual retail buyer through a vehicle customization process.

FIGS. 3A-3B are flow charts depicting an exemplary process for guiding a current individual retail buyer through an extended vehicle customization process, wherein the extended vehicle customization process includes determining design configurations for a plurality of design element categories.

FIG. 4 is a flow chart depicting an exemplary process for ensuring compatibility between selected design elements of a made-to-order vehicle for a current individual retail buyer.

### DETAILED DESCRIPTION

One aspect of the disclosure is directed to a method of guided customization for ensuring compatibility between selected design elements of a made-to-order vehicle for a current individual retail buyer.

References throughout this document to “one embodiment,” “certain embodiments,” “an embodiment,” or similar term mean that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. For example, two or more of the innovative devices described herein may be combined in a single device, but the application is not limited to the specific exemplary combinations of a method of guided customization that are described herein.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

A detailed description of various embodiments is provided; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the disclosed embodiments.

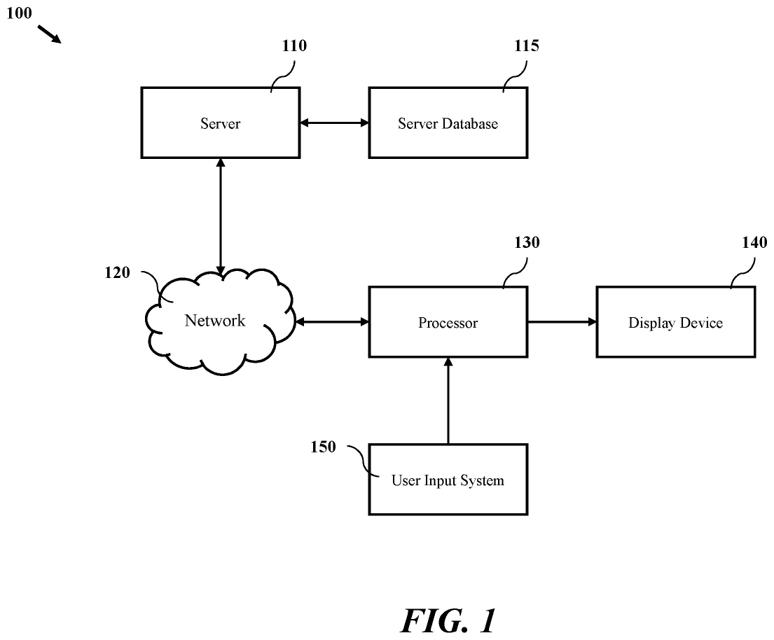

FIG. 1 is a graphical representation of an exemplary embodiment of a system 100 for implementing a method for ensuring compatibility between selected design elements of a made-to-order vehicle for a current individual retail buyer. According to one embodiment, the system 100 comprises a server 110, a server database 115, a network 120, a processor 130, a display device 140, and a user input system 150. The server 110 may be responsible for managing data within the server database 115, including storing and retrieving data pertaining to a method for ensuring compatibility between selected design elements of a made-to-order vehicle (hereinafter “guided customization data”) for a current individual retail buyer. The guided customization data may include data regarding the various design element options available to the current individual retail buyer. The server 110 may, at the request of the processor 130 or by its own initiative, transmit the guided customization data by the network 120 to the processor 130. The processor 130 may interpret the guided customization data and display relevant elements of the guided customization data on the display device 140 such that the current individual retail buyer may make informed decisions while navigating the guided customization. The system 100 may record the current individual retail buyer's selections and decisions regarding the guided customization by means of the user input system 150. The user input system 150 may include one or more of, for example, a keyboard, a computer mouse, a microphone, and/or a camera.

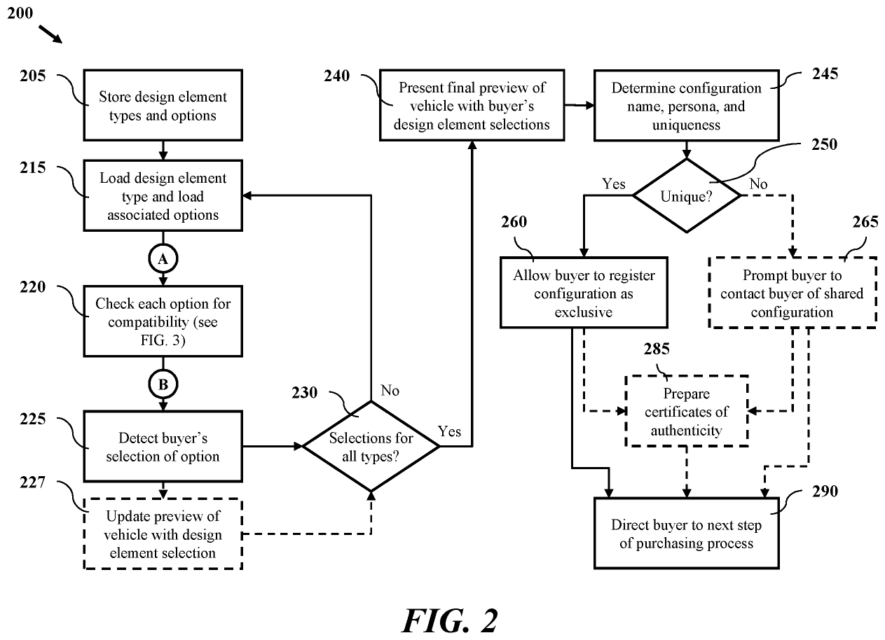

FIG. 2 is a flow chart depicting an exemplary process for guiding a current individual retail buyer through a vehicle customization process 200.

During step 205, according to one embodiment, the designer interacts with the system to enable the processor to store design element types and design element options for use with the vehicle customization process 200. Design element types may include, for example, interior leather, interior thread, interior plating, interior jewel, exterior paint, exterior finish, wheel finish, sound system, and biometric recognition system. Design element options are each associated with a design element type and may be, for example, a plurality of color options for leather surfaces. According to one embodiment, a personalized sound zone system may be offered as a design element option. When the made-to-order vehicle is completed with the personalized sound zone system option selected, the personalized sound zone system may assign an isolated sound zone to each occupant of the made-to-order vehicle. Each isolated sound zone may be individually configurable as part of the vehicle customization process 200 and/or during operation of the completed made-to-order vehicle. According to one embodiment, the biometric recognition systems that are design element options are able to identify occupants of the made-to-order vehicle and load personal settings for each of the occupants of the made-to-order vehicle based on recognized biometrics of the occupants of the made-to-order vehicle.

During step 215, according to one embodiment, the vehicle customization process 200 operates via the processor and/or server to enable the processor to load one of the stored design element types and load options associated with the selected design element type.

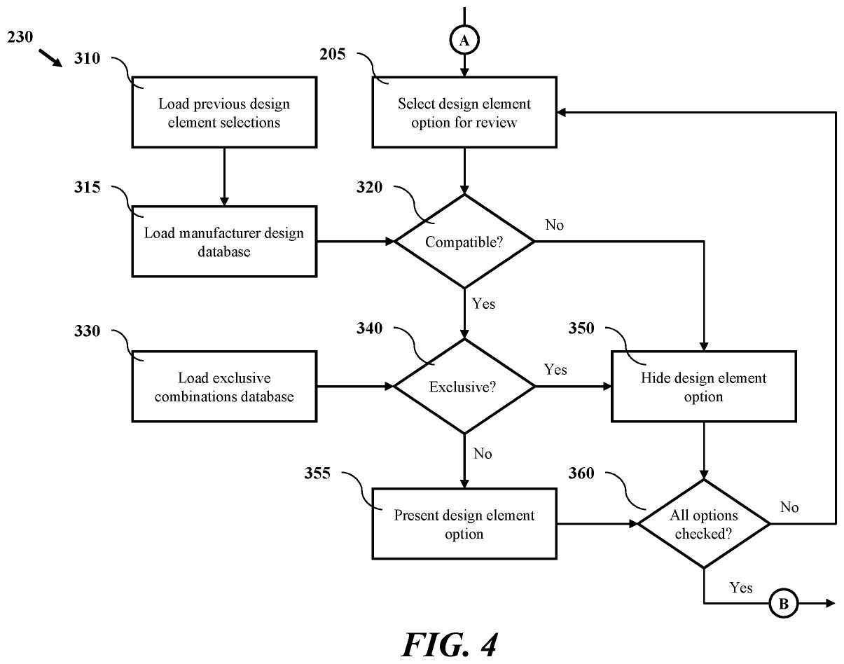

During step 220, according to one embodiment, the vehicle customization process 200 operates via the processor and/or server to check each option associated with the design element type chosen during step 215 for compatibility (see FIG. 4). A subset of the options may be displayed to the current individual retail buyer and a subset of options may be hidden from the current individual retail buyer based on the results of the process during step 220.

During step 225, according to one embodiment, the vehicle customization process 200 operates via the processor and/or server to detect the current individual retail buyer's selection of an option for the currently loaded design element type from the plurality of options displayed to them. This selection may be registered and stored for future compatibility checks during step 220.

During step 227, according to one embodiment, the vehicle customization process 200 may operate via the processor and/or server to optionally update a computer generated preview displaying a vehicle including the design element selection made during step 225. The computer generated preview may include all other design element selections made up to this point. The computer generated preview may allow the current individual retail buyer to alternate between an interior view and an exterior view of the vehicle.

During step 230, according to one embodiment, the vehicle customization process 200 operates via the processor and/or server to determine if the current individual retail buyer has made a selection for each stored design element type. If the current individual retail buyer has not made a selection for each stored design element type, then the vehicle customization process 200 returns to step 215 to cause the processor to load another design element type so that the current individual retail buyer may make a selection for that design element type. Otherwise, the vehicle customization process 200 proceeds to the next step.

During step 240, according to one embodiment, the vehicle customization process 200 operates via the server and process to present a final preview of a vehicle including a combination of the design element selections (hereinafter “design configuration”) made throughout the vehicle customization process 200. The preview may present an interior view or exterior view of the vehicle depending on the design element types, and the preview may allow the current individual retail buyer to alternate between an interior view and an exterior view of the vehicle.

During step 245, according to one embodiment, the vehicle customization process 200 operates via the processor and/or server to determine a name, a “persona”, and/or a uniqueness of the design configuration. The name of the category design configuration may be determined based on the design element selections. For example, an interior design configuration with black, gray, and blue color selections may be labeled “black ice” based on a predetermined design association. A persona may be a name chosen to indicate the personality and character of the design configuration. The vehicle customization process 200 may assign a persona based on at least one of the selections made for a given design element type, or it may assign a persona based on a subset of the selections made. The uniqueness of the design configuration may be determined by checking a database to find if any previous individual retail buyers have already purchased the same design configuration. The vehicle customization process 200 may operate via the processor and/or server to communicate the name, persona, and uniqueness of the design configuration to the current individual retail buyer.

During step 250, according to one embodiment, the vehicle customization process 200 operates via the processor and/or server to check if the design configuration is unique (i.e. has not been commissioned by one or more previous individual retail buyers). If the design configuration is unique, the vehicle customization process 200 during step 260 may operate via the processor and/or server to offer to the current individual retail buyer the option to “buy out” the design configuration, thereby registering the design configuration as exclusive. Registering the design configuration as exclusive may restrict the vehicle customization process 200 from presenting design element options comprising the design configuration to a future individual retail buyer (see step 340 of FIG. 4), either in part or as a whole. Otherwise, according to one embodiment, during step 265 the vehicle customization process 200 may operate via the processor and/or server to optionally prompt the current individual retail buyer to connect with the previous individual retail buyer that previously purchased the design configuration. Connecting may be, for example, communicating to the previous individual retail buyer by e-mail, physical mail, or phone.

During step 285, according to one embodiment, the vehicle customization process 200 may operate via the processor and/or server to optionally prepare a plurality of certificates of authenticity for each of the design element selections, wherein the plurality of prepared certificates of authenticity is produced and shipped with the customized vehicle once the purchasing process is completed. According to one embodiment, each of the plurality of the produced certificates of authenticity may be signed and numbered with a serial number. According to one embodiment, the vehicle customization process 200 may prepare and produce a certificate of authenticity for the customized vehicle itself.

During step 290, according to one embodiment, the vehicle customization process 200 operates via the processor and/or server to direct the current individual retail buyer to the next step of the vehicle purchasing process. The design configuration may be used in determining factors in the next step of the purchasing process which may be, for example, the cost, manufacturing time, and delivery options of the customized vehicle.

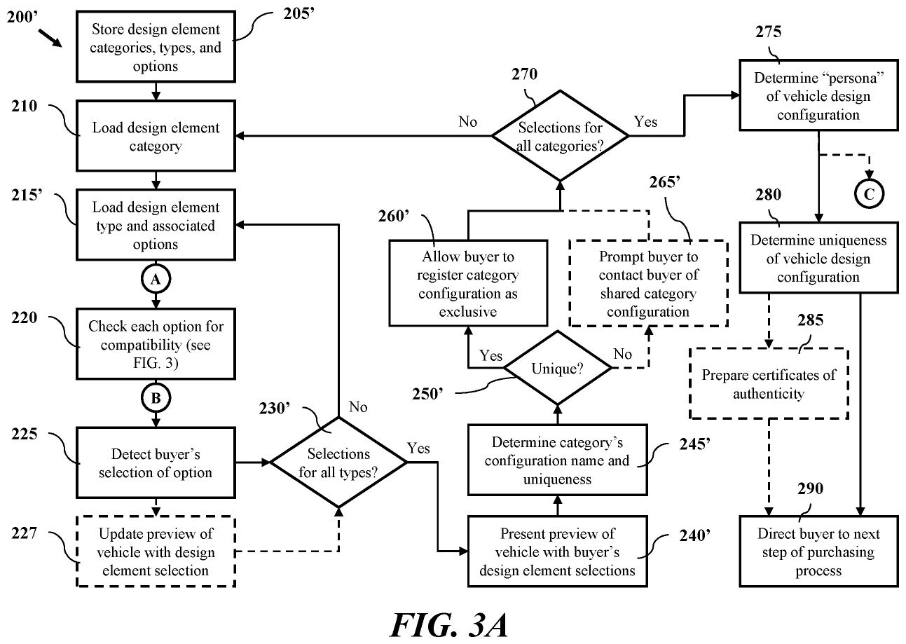

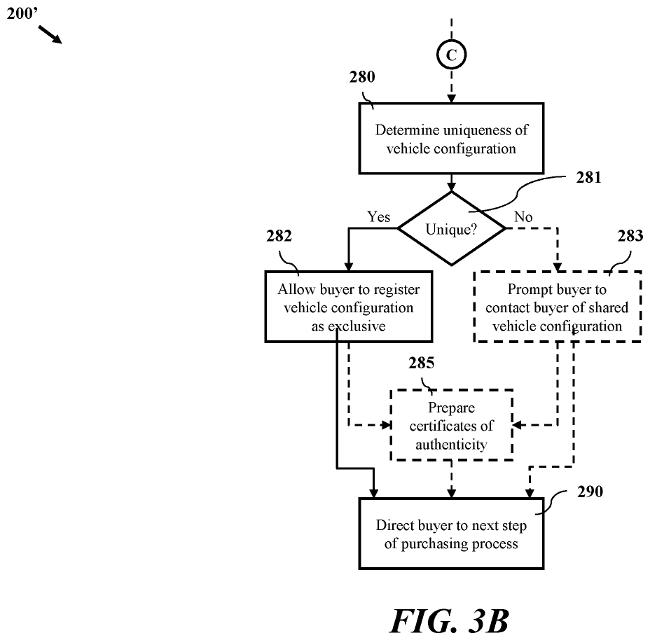

FIGS. 3A-3B are flow charts depicting an exemplary process for guiding a current individual retail buyer through an extended vehicle customization process 200′, wherein the extended vehicle customization process 200′ includes determining design configurations for a plurality of design element categories.

During step 205′, according to one embodiment, the designer interacts with the system to cause the processor and server to store design element categories, design element types, and design element options for use with the extended vehicle customization process 200′. Design element categories may include, for example, for example, interior design elements, exterior design elements, and technological design elements. Design element types may include, for example, interior leather, interior thread, interior plating, interior jewel, exterior paint, exterior finish, wheel finish, and sound system. Design element options are each associated with a design element type and may be, for example, a plurality of color options for leather surfaces. Design element types may each be categorized into one of the design element categories, and design element options may each be associated with one of the design element types.

During step 210, according to one embodiment, the extended vehicle customization process 200′ operates via the processor and/or server to load one of the design element categories in order to allow the current individual retail buyer to make design element selections for the design element types categorized in the currently loaded design element category.

During step 215′, according to one embodiment, the extended vehicle customization process 200′ operates via the processor and/or server to load one of the stored design element types and loads options associated with the selected design element type, wherein the loaded design element type is categorized into the currently loaded design element category. Options may be, for example, a plurality of color options for leather surfaces.

During step 220, according to one embodiment, the extended vehicle customization process 200′ operates via the processor and/or server to check each option associated with the design element type chosen during step 215′ for compatibility (see FIG. 4). A subset of the options may be displayed to the current individual retail buyer and a subset of options may be hidden from the current individual retail buyer based on the results of the process during step 220.

During step 225, according to one embodiment, the extended vehicle customization process 200′ operates via the processor and/or server to detect the current individual retail buyer's selection of an option from the plurality of options displayed to them. This selection may be registered and stored for future compatibility checks during step 220.

During step 227, according to one embodiment, the extended vehicle customization process 200′ may operate via the processor and/or server to optionally update a computer generated preview displaying a vehicle including the design element selection made during step 225. This preview may include all other design element selections for the currently loaded design element category made up to this point. This preview may allow the current individual retail buyer to alternate between an interior view and an exterior view of the vehicle.

During step 230′, according to one embodiment, the extended vehicle customization process 200′ operates via the processor and/or server to determine if the current individual retail buyer has made a selection for each design element type categorized in the currently loaded design element category. If the current individual retail buyer has not made a selection for each design element type categorized in the currently loaded design element category, then the extended vehicle customization process 200′ returns to step 215′ and operates via the processor and/or server to load another design element type that is categorized in the currently loaded design element category so that the current individual retail buyer may make a selection for that design element type. Otherwise, the extended vehicle customization process 200′ proceeds to the next step.

During step 240′, according to one embodiment, the extended vehicle customization process 200′ operates via the processor and/or server to present a preview of a vehicle including a combination of the design element selections for the currently loaded design element category (hereinafter “category design configuration”) made throughout the vehicle customization process 200′. The preview may present an interior view or exterior view of the vehicle depending on the design element types, and the preview may allow the current individual retail buyer to alternate between an interior view and an exterior view of the vehicle.

During step 245′, according to one embodiment, the extended vehicle customization process 200′ operates via the processor and/or server to determine a name for and uniqueness of the category design configuration. The name of the category design configuration may be determined based on the design element selections. For example, an interior design configuration with black, gray, and blue color selections may be labeled “black ice” based on a predetermined design association. The uniqueness of the category design configuration may be determined by checking a database to find if any previous individual retail buyers have already purchased the same category design configuration for the currently loaded design element category. The extended vehicle customization process 200′ may operate via the processor and/or server to communicate the name and uniqueness of the category design configuration to the current individual retail buyer.

During step 250′, according to one embodiment, the extended vehicle customization process 200′ operates via the processor and/or server to check if the category design configuration is unique (i.e. has not been commissioned in construction of a custom vehicle for the currently loaded category by one or more previous individual retail buyers). If the category design configuration is unique, the extended vehicle customization process 200′ during step 260′ may operate via the processor and/or server to offer to the current individual retail buyer the option to “buy out” the category design configuration, thereby registering the category design configuration as exclusive. Registering the category design configuration as exclusive may restrict the extended vehicle customization process 200′ from presenting design element options comprising the category design configuration to a future individual retail buyer (see FIG. 3), either in part or as a whole. Otherwise, according to one embodiment, during step 265′ the extended vehicle customization process 200′ may optionally operate via the processor and/or server to prompt the current individual retail buyer to connect with the previous individual retail buyer that previously purchased the category design configuration. Connecting may be, for example, communicating to the previous individual retail buyer by e-mail, physical mail, or phone.

During step 270, according to one embodiment, the extended vehicle customization process 200′ operates via the processor and/or server to determine if the current individual retail buyer has made a category design configuration selection for each stored design element category. If the current individual retail buyer has not made a selection for each stored design element category, then the extended vehicle customization process 200′ returns to step 210 to load another design element category so that the current individual retail buyer may make a category design configuration selection for that design element category. Otherwise, the extended vehicle customization process 200′ proceeds to the next step.

During step 275, according to one embodiment, the extended vehicle customization process 200′ operates via the processor and/or server to assign a “persona” to the design configuration of the vehicle as a whole (hereinafter “vehicle design configuration”). A persona may be a name chosen to indicate the personality and character of the vehicle design configuration. The extended vehicle customization process 200′ may assign a persona based on at least one of the selections made for a given design element type, or it may assign a persona based on a subset of the selections made. The extended vehicle customization process 200′ may operate via the processor and/or server to communicate the persona of the vehicle design configuration to the current individual retail buyer.

During step 280, according to one embodiment, the extended vehicle customization process 200′ operates via the processor and/or server to check if the vehicle design configuration is unique (i.e. has not been commissioned in construction of a custom vehicle for the currently loaded category by one or more previous individual retail buyers). If the vehicle design configuration is unique, the extended vehicle customization process 200′ may operate via the processor and/or server to communicate this information to the current individual retail buyer. The extended vehicle customization process may optionally include steps 281, 282, and 283 (see the branch leading to point C, corresponding to point C of FIG. 3B). If the vehicle design configuration is unique, the extended vehicle customization process 200′ during step 282 may operate via the processor and/or server to offer to the current individual retail buyer the option to “buy out” the vehicle design configuration, thereby registering the vehicle design configuration as exclusive. Registering the vehicle design configuration as exclusive may restrict the extended vehicle customization process 200′ from presenting design element options comprising the vehicle design configuration to a future individual retail buyer (see step 340 of FIG. 4), either in part or as a whole. Otherwise, according to one embodiment, during step 283 the extended vehicle customization process 200′ may operate via the processor and/or server to optionally prompt the current individual retail buyer to connect with the previous individual retail buyer that previously purchased the vehicle design configuration. Connecting may be, for example, communicating to the previous individual retail buyer by e-mail, physical mail, via the automotive manufacturer's secure website or phone.

During step 285, according to one embodiment, the extended vehicle customization process 200′ operates via the processor and/or server to prepare a plurality of certificates of authenticity for each of the design element selections, wherein the plurality of prepared certificates of authenticity is produced and shipped with the customized vehicle once the purchasing process is completed. According to one embodiment, each of the plurality of the produced certificates of authenticity may be signed and numbered with a serial number. According to one embodiment, the extended vehicle customization process 200′ may prepare and produce a certificate of authenticity for the customized vehicle itself.

During step 290, according to one embodiment, the extended vehicle customization process 200′ operates via the processor and/or server to direct the current individual retail buyer to the next step of the vehicle purchasing process. The category design configurations may be used in determining factors in the next step of the purchasing process which may be, for example, the cost, manufacturing time, and delivery options of the customized vehicle.

FIG. 4 is a flow chart depicting an exemplary process for ensuring compatibility between selected design elements of a made-to-order vehicle for a current individual retail buyer. Specifically, FIG. 4 is a depiction of the portion of the vehicle customization process 200 depicted in FIGS. 2 and 3 between point A of FIG. 2 and point B of FIG. 2 or between point A of FIG. 3A and point B of FIG. 3A (i.e. step 220), wherein the vehicle customization process 200 checks each option associated with the design element type chosen during step 220 for compatibility. According to one embodiment, the following descriptions of FIG. 4 apply to the extended vehicle customization process 200′ as well as the vehicle customization process 200, and references within the FIG. 4 description to the vehicle customization process 200′ should be interpreted as such.

During step 305, according to one embodiment, the vehicle customization process 200 operates via the processor and/or server to select a design element option to be checked for compatibility (hereinafter “option under review”).

During step 310, according to one embodiment, the vehicle customization process 200 operates via the processor and/or server to load the selections of design element options, if any, that the current individual retail buyer has made. The loaded selections of design element options may be loaded from the design element options that have been selected and stored as part of the process during step 235 of FIG. 2. During step 315, according to one embodiment, the vehicle customization process 200 operates via the processor and/or server to load a manufacturer design database. The manufacturer design database may be predeveloped and predetermined so as to restrict the current individual retail buyer to selecting design element options that are predetermined by a designer to be compatible with previously selected design element options.

During step 320, according to one embodiment, the vehicle customization process 200 operates via the processor and/or server to compare the option under review against the selections of design element options loaded during step 310 (hereinafter “previous selections”) based on the manufacturer design database loaded during step 315. If the option under review is found to be incompatible with the previous selections, then the vehicle customization process 200 may hide the option under review from the current individual retail buyer during step 350.

If the option under review is found to be compatible with the previous selections, then the vehicle customization process 200 operates via the processor and/or server to load an exclusive combinations database during step 330, according to one embodiment. The exclusive combinations database may be populated with combinations of selected design element options that previous individual retail buyers have registered as exclusive during step 270 of the vehicle customization process 200.

During step 340, according to one embodiment, the vehicle customization process 200 operates via the processor and/or server to compare the option under review and the previous selections against the exclusive combinations database loaded during step 330. If the option under review combined with the previous selections would result in a combination matching one of the exclusive combinations in the exclusive combinations database loaded during step 330, then the vehicle customization process 200 may hide the option under review from the current individual retail buyer during step 350.

If the option under review is found to be compatible with the previous selections and if the option under review combined with the previous selections would not result in a combination matching one of the exclusive combinations in the exclusive combinations database loaded during step 330, then the vehicle customization process 200 operates via the processor and/or server to present the option under review to the current individual retail buyer for possible selection during step 355, according to one embodiment. In one embodiment, presentation of the option under review is performed by a display device for a user interface.

During step 360, according to one embodiment, after an option under review has been hidden or presented, the vehicle customization process 200 operates via the processor and/or server to check if all design element options associated with the current design element type have been checked for compatibility and exclusivity. If all design element options associated with the current design element type have been checked for compatibility and exclusivity, then the vehicle customization process 200 proceeds to wait and detect the current individual retail buyer's selection of an option from the plurality of options displayed to them during step 225 of FIGS. 2 and 3A. Otherwise, the vehicle customization process returns to step 305 to select another design element option for review.

While this disclosure makes reference to exemplary embodiments, it will be understood by those skilled in the art that various changes in form and details may be made therein without departing from the scope of the claimed embodiments.

What is claimed is:

1. A method of guided customization for ensuring compatibility between selected design elements of a made-to-order vehicle for a current individual retail buyer, wherein the method operates using a server, server database and a processor configured to provide for interaction with the buyer, the method comprising steps of:
storing a plurality of design element types in a database, each design element type having a plurality of possible design element options;
selecting a first design element type from the plurality of stored design element types and presenting the possible design element options for the first design element type to the buyer on a display device;
recognizing a selection, by the current individual retail buyer, of a first design element option from the plurality of possible design element options for the first design element type;
repeating the selecting and recognizing process for a next design element type until a selection has been recognized for each of the plurality of design element types,
wherein the presenting of possible design element options for the next design element type is restricted based on a recognized selection of a previous design element option for a previous design element type, and
wherein the restriction based on the recognized selection of a previous design element option is based on a plurality of restriction criteria including manufacturer recommended combinations, design element manufacturing availability, and exclusivity rights of a previous individual retail buyer;
combining each of the recognized selections for each of the plurality of design element types combine into a design configuration;
communicating to the current individual retail buyer via the display device how many times the design configuration has been ordered; and
if the design configuration is unique, allowing the current individual retail buyer to register the design configuration as exclusive with respect to restricting design element options for a future individual retail buyer.

2. The method of claim 1, wherein each of the plurality of design element types is categorized as an interior design element, exterior design element, or technological design element.

3. The method of claim 2, wherein design element types categorized as interior design elements include types of thread, leather, textile, jewel, interior plating, control interfaces, floor mats, unique customer insignia, and manufacturer numbered insignia.

4. The method of claim 2, wherein design element types categorized as exterior design elements include types of paint, finishes, wheel finishes, calipers, unique customer insignia, and manufacturer numbered insignia.

5. The method of claim 2, wherein design element types categorized as technological design elements include types of sound systems, biometric recognition systems, screen applications, application stores, customized ecosystem, manufacturer ID feature configuration, advanced humanized machine interface, advanced welcome features, and advanced security features.

6. The method of claim 5, wherein sound systems includes isolated sound zones for occupants of the made-to-order vehicle, wherein an isolated sound zone is assigned to each occupant of the made-to-order vehicle, and wherein each isolated sound zone is individually configurable.

7. The method of claim 5, wherein the biometric recognition systems are able to identify occupants of the made-to-order vehicle and load personal settings for each of the occupants of the made-to-order vehicle based on recognized biometrics of the occupants of the made-to-order vehicle.

8. The method of claim 1, wherein the method includes presenting, to the current individual retail buyer, a preview of the selected design element options as a computer generated image, and wherein the current individual retail buyer may adjust the presentation of the preview of the selected design element options.

9. The method of claim 1, wherein the manufacturer recommended combinations are based on a categorization of the combination of the selected design element options into a persona.

10. The method of claim 9, wherein the method includes communicating the categorization of persona to the current individual retail buyer.

11. A method of guided customization for ensuring compatibility between selected design elements of a design element category of a made-to-order vehicle for a current individual retail buyer, wherein the method operates using a server, server database and a processor configured to provide for interaction with the buyer, the method comprising steps of:
storing a plurality of design element types in a database, each design element type having a plurality of possible design element options;
selecting a first design element type from the plurality of stored design element types and presenting the possible design element options for the first design element type to the buyer on a display device;
recognizing a selection, by the current individual retail buyer, of a first design element option from the plurality of possible design element options for the first design element type;
repeating the selecting and recognizing process for a next design element type until a selection has been recognized for each of the plurality of design element types,
wherein the presenting of possible design element options for the next design element type is restricted based on a recognized selection of a previous design element option for a previous design element type, and
wherein the restriction based on the recognized selection of a previous design element option is based on a plurality of restriction criteria including manufacturer recommended combinations, design element manufacturing availability, and exclusivity rights of a previous individual retail buyer;
combining each of the recognized selections for each of the plurality of design element types combine into a category design configuration;
communicating to the current individual retail buyer how many times the category design configuration has been ordered; and
if the category design configuration is unique, allowing the current individual retail buyer to register the category design configuration as exclusive with respect to restricting design element options for a future individual retail buyer.

12. The method of claim 11, wherein the category of design elements is chosen from a set of categories including interior design elements, exterior design elements, and technological design elements.

13. The method of claim 12, wherein design element types categorized as interior design elements include types of thread, leather, textile, jewel, interior plating, control interfaces, floor mats, unique customer insignia, and manufacturer numbered insignia.

14. The method of claim 12, wherein design element types categorized as exterior design elements include types of paint, finishes, wheel finishes, calipers, unique customer insignia, and manufacturer numbered insignia.

15. The method of claim 12, wherein design element types categorized as technological design elements include types of sound systems, biometric recognition systems, screen applications, application stores, ecosystem, manufacturer ID feature configuration, advanced humanized machine interface, welcome features, and security features.

16. The method of claim 15, wherein sound systems includes isolated sound zones for occupants of the made-to-order vehicle, wherein an isolated sound zone is assigned to each occupant of the made-to-order vehicle, and wherein each isolated sound zone is individually configurable.

17. The method of claim 15, wherein the biometric recognition systems are able to identify occupants of the made-to-order vehicle and load personal settings for each of the occupants of the made-to-order vehicle based on recognized biometrics of the occupants of the made-to-order vehicle.

18. The method of claim 11, wherein the method includes presenting, to the current individual retail buyer on the display device, a preview of the selected design element options as a computer generated image, and wherein the current individual retail buyer may adjust the presentation of the preview of the selected design element options.

19. The method of claim 11, wherein the manufacturer recommended combinations are based on a categorization of the combination of the selected design element options into a persona.

20. The method of claim 19, wherein the method includes communicating the categorization of persona to the current individual retail buyer.
